(19) United States
(12) Patent Application Publication
(10) Pub. No.: US 2018/0361641 A1
(43) Pub. Date: Dec. 20, 2018

(54) WALL MOUNTED WASHING MACHINE, AND TUB-INTERGRATED REAR PANEL AND MANUFACTURING MOLD FOR MANUFACTURING THE SAME

(71) Applicant: DONGBU DAEWOO ELECTRONICS CORPORATION, Seoul (KR)

(72) Inventor: Jong Jin LEE, Incheon (KR)

(21) Appl. No.: 15/943,621

(22) Filed: Apr. 2, 2018

(30) Foreign Application Priority Data
Jun. 14, 2017 (KR) 10-2017-0074628

(51) Int. Cl. B29C 45/26; D06F 39/14; D06F 33/02; D06F 37/28; D06F 39/08; D06F 37/22; D06F 23/02; D06F 39/02

(52) U.S. Cl. CPC B29C 45/2602; D06F 39/14; D06F 33/02; D06F 37/28; D06F 39/024; D06F 39/083; D06F 37/22; D06F 23/02; D06F 39/088

(57) ABSTRACT

The present disclosure relates to a wall mounted washing machine, a tub-integrated rear panel of the wall-mounted washing machine, and a manufacturing mold for manufacturing the tub-integrated rear panel of the wall mounted washing machine. In accordance with an aspect of the disclosure, a wall mounted washing machine includes a rear panel operable to be mounted on a wall surface; a tub formed integrally with the rear panel and extending forward from the rear panel and operable to be filled with wash water; a drum installed in the tub to be rotatable by power from a driving motor; a front panel formed in front of the tub and having an opening; a cover installed on the front panel and covering the front panel; a door rotatably coupled to the cover for opening or closing the laundry inlet of the cover; and a cabinet coupled to the rear panel and enclosing the tub.

### RELATED CASE

This patent application claims benefit to Korean Patent Application No. 10-2017-0074628 filed Jun. 14, 2017, with inventor Jong Jin LEE, and whose specification is incorporated by reference herein.

### TECHNICAL FIELD

The disclosure relates to a wall mounted washing machine, a tub-integrated rear panel of the wall-mounted washing machine, and a manufacturing mold for manufacturing the tub-integrated rear panel of the wall mounted washing machine.

### BACKGROUND

A washing machine is a device for separating contaminants from washed fabric (laundry) using wash water and detergent, wherein the contaminants may be separated from the washed fabric by the chemical action of the detergent dissolved in the wash water and the mechanical action of the wash water and an inner basket. Such washing machines may be categorized into a top loading type washing machine, a front loading type washing machine, and a combined type washing machine combined with the top loading type and the front loading type, depending on the method of loading the laundry.

In recent years, wall mounted washing machines have been introduced, which may be installed in narrow spaces such as bathrooms and toilets. In general, the wall mounted washing machines employ the front loading type for better miniaturization.

For example, the wall mounted washing machine may include a cabinet that forms an exterior, a tub provided in the cabinet filled with wash water, a drum rotatably installed in the tub and accommodating the laundry, a drive unit providing power to the drum, a water supply unit for supplying the wash water to the tub, and a drain unit for discharging the wash water from the tub to the outside of the cabinet.

This wall mounted washing machine is configured in such a form that the tub protrudes from the rear panel mounted on the wall. The connection part between the tub and the rear panel can become damaged by the vibration due to the driving part and the load due to the wash water in the tub. In order to prevent this, a reinforcing structure as shown in FIG. 1 was provided at a connecting portion between the rear panel and the tub.

Referring to FIG. 1, a reinforcing portion 3 is formed between a rear panel 1 and a tub 2 in the reinforcing structure of the prior art. The reinforcing portion 3 is formed to have a larger diameter than the diameter of the tub 2 and to protrude from the front surface of the rear panel 1 surrounding the outer circumferential surface of the tub 2. Specifically, the rear panel 1, the reinforcing portion 3, and the tub 2 are formed with stepped steps.

In this case, since the width between the outer circumferential surface of the tub 2 surrounding the reinforcing portion 3 and the inner circumferential surface of the reinforcing portion 3 is very narrow, it is difficult to insert the cooling line for cooling an injection product during the injection molding process. Accordingly, the cold air may not be directly transmitted between the outer circumferential surface of the tub 2 and the inner circumferential surface of the reinforcing portion 3. Therefore, it is necessary to wait until cool air is transmitted from a cooling line disposed around the outer circumferential surface of the tub 2 and ribs 5 disposed on the rear surface of the rear panel 1, and thus the cooling speed in the inside of the reinforcing portion 3 is slower than the other portions. As a result, there is a problem that the cooling cycle time is disadvantageously increased in the prior art.

In addition, since the reinforcing portion 3 is formed to surround the tub 2 with a diameter larger than the diameter of the tub 2, the available inner space between the rear panel 1 and the cabinet is reduced. Thus, there is a problem in that the available space for arranging a structure such as the drain to be installed therein is reduced.

### SUMMARY

In view of the foregoing, embodiments of the disclosure provide a wall-mounted washing machine including a rear panel and a tub integrally injection molded, a tub-integrated rear panel of the wall-mounted washing machine, and a manufacturing mold for manufacturing the tub-integrated rear panel of the wall mounted washing machine.

In addition, embodiments of the disclosure provide a wall-mounted washing machine in which the cooling cycle time is made short for the injection molding phase, a tub-integrated rear panel of the wall-mounted washing machine, and a manufacturing mold for manufacturing the tub-integrated rear panel of the wall-mounted washing machine.

In addition, embodiments of the disclosure provide a wall-mounted washing machine in which the strength of the connection portion between the tub and the rear panel is reinforced, an tub-integrated rear panel of the wall-mounted washing machine, and a manufacturing mold for manufacturing the tub-integrated rear panel of the wall-mounted washing machine.

Embodiments of the present invention are drawn to a wall mounted washing machine comprising: a rear panel operable to be mounted on a wall surface; a tub formed integrally with the rear panel and extending forward thereof and operable to contain wash water wherein the tub comprises with a strength reinforcing portion; a drum disposed in the tub and rotatable; a front panel disposed in front of the tub and having an opening; a cover disposed to cover the front panel and having an inlet; a door rotatably coupled to the cover for selectively opening and closing the inlet; and a cabinet coupled to the rear panel and enclosing the tub, wherein the strength reinforcing portion comprises: a plurality of first ribs disposed at connecting portions of the tub and a front surface of the rear panel and vertically extending from the front surface of the rear panel and connected to a first outer circumferential surface of the tub; second ribs protruding from the first outer circumferential surface of the tub perpendicular to the first ribs and formed in parallel with the front surface of the rear panel and having a strip shape; and a plurality of third ribs extending perpendicular to the second ribs from a front surface of the second ribs to a front end portion of the tub and connected to a second outer circumferential surface of the tub, wherein further the first and second outer circumferential surfaces of the tub are formed free of any stepped shape. Embodiments include the above and wherein some of the first ribs protrude upward, some of the first ribs protrude left, some the first ribs protrude right, and some of the third ribs protrude upward, some of the third ribs protrude left, and some of the third ribs protrude right. Embodiments include the above and wherein a space between some of the first ribs and the third ribs protruding upward and some of the first ribs and the third ribs protruding left and a space between some of the first ribs and the third ribs protruding upward and some of the first ribs and the third ribs protruding right are disposed with the first ribs and the third ribs protruding in a direction perpendicular to a tangent direction of the tub.

Embodiments include the above and wherein respective third ribs are disposed to face end portions of the first ribs with respect to the second ribs, and make a same angle with respect to the tub. Embodiments include the above and wherein some of the first ribs do not face the third ribs. Embodiments include the above and wherein the first ribs and the third ribs protruding from the first and second outer circumferential surfaces of the tub are equal in height to each other and the second ribs protrude higher than the first ribs. Embodiments include the above and further comprising: a heater disposed under the tub and wherein a heater accommodating portion is installed with the heater; a drain hole formed in the heater accommodating portion; a drain unit installation part formed on a lower side of the drain hole and protruded and formed on a front surface of the rear panel, and wherein a region wherein the drain unit installation part is formed is free of first ribs. Embodiments include the above and further comprising a control unit installed on one side of the rear panel and comprising a circuit comprising electronic components which protrude toward the tub, wherein the control unit is installed at a position wherein a distance between protruding end portions of the electronic components and a tub surface is shorter than a protrusion height of the third ribs, and wherein further a portion of the tub facing the control unit is free of any third ribs.

Embodiments of the present invention are also drawn to, in a wall mounted washing machine having a rear panel operable to be fixed to a wall and a tub extending forward from the rear panel, wherein the rear panel is injection-molded with the tub, a reinforcing portion for reinforcing a strength of the tub, wherein the reinforcing portion comprises: a plurality of first ribs provided on a connecting portion of a front surface of the tub and the rear panel and extending forward from a front surface of the rear panel and connected to a first outer circumferential surface of the rear panel; second ribs protruding from the first outer circumferential surface of the tub in a strip shape and facing a front surface of the rear panel; and a plurality of third ribs extending from a front surface of the second ribs to a front end portion of the tub and connected to a second outer circumferential surface of the tub, and wherein the first and second outer circumferential surfaces of the tub being formed free of a stepped shape. Embodiments include the above and wherein the first ribs are formed perpendicular to a front surface of the rear panel. Embodiments include the above and wherein the second ribs protrude perpendicular to the tub and are formed parallel to a front surface of the rear panel. Embodiments include the above and wherein the third ribs are located on same lines as are the first ribs.

Embodiments include the above and wherein the first ribs and the third ribs disposed on a boundary of a mold for manufacturing the tub and rear panel protrude in a direction perpendicular to a tangent of the tub. Embodiments include the above and wherein the wall mounted washing machine further comprises: a heater having a heater accommodating portion and disposed below the tub; a drain hole for draining wash water and formed in the heater accommodating portion; and a drain unit installation part on which a drain unit is disposed and positioned below the drain hole, and wherein further a region where the drain unit installation part protrudes is free of first ribs. Embodiments include the above and wherein the wall mounted washing machine further comprises: a control unit comprising a circuit comprising electronic components that protrude toward the tub and is installed on one side of the rear panel, wherein the control unit is installed at a position wherein a distance between a protruding end portion of the electronic components and the tub surface is shorter than a protrusion height of the third ribs, and wherein further third ribs are not formed in a portion of the tub facing the control unit.

Embodiments of the present invention are also drawn to a manufacturing mold for injection molding a tub-integrated rear panel for a wall mounted washing machine, the manufacturing mold comprising: a first mold forming a rear surface of the rear panel, the rear surface of the rear panel being disassembled; a second mold forming a front surface of the tub, the second mold being disassembled forward of the tub; a third mold forming an upper portion of the rear panel and an upper portion of the tub, the third mold being disassembled above the rear panel; a fourth mold forming a left portion of the rear panel and a left portion of the tub, the fourth mold being disassembled in the left direction of the rear panel; a fifth mold forming a lower portion of the rear panel and a lower portion of the tub, the fifth mold being downwardly disassembled in the rear panel; and a sixth mold forming a right portion of the rear panel and a right portion of the tub, the sixth mold being disassembled in the right direction of the rear panel, wherein the third mold, the fourth mold, and the sixth mold comprise: rib holes for forming a plurality of first ribs provided on a connecting portion of a front surface of the tub and the rear panel, the first ribs extending forward from a front surface of the rear panel and connected to a first outer circumferential surface of the rear panel; second ribs protruding from the first outer circumferential surface of the tub in a strip shape and facing the front surface of the rear panel; and a plurality of third ribs extending from a front surface of the second ribs to a front end portion of the tub and connected to a second outer circumferential surface of the tub, and wherein the first and second outer circumferential surfaces of the tub are formed without a stepped shape.

Embodiments include the above and wherein the first ribs are formed perpendicular to the front surface of the rear panel, the second ribs are formed in parallel with the front surface of the rear panel and protrude vertically from the tub, and the third ribs are formed on same lines as are formed the first ribs. Embodiments include the above and wherein the first ribs and the third ribs disposed at a boundary between the third mold and the sixth mold and a boundary between the third mold and the fourth mold protrude in a direction perpendicular to a tangent of the tub.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view of a wall mounted washing machine of the prior art and an enlarged view showing a reinforcing portion; FIG. 2 is a perspective view showing the appearance of a wall mounted washing machine according to an embodiment of the present disclosure;

FIG. 3 is a view showing a state in which the door of FIG. 2 is open.

FIG. 4 is a rear perspective view of the washing machine of FIG. 2;

FIG. 5 is an exploded perspective view of the washing machine of FIG. 2;

FIG. 6 is a perspective view showing the side surfaces of the rear panel and the tub in FIG. 5;

FIG. 7 is a perspective view showing the side surfaces of the rear panel and the tub in FIG. 5;

FIG. 8 is a cross-sectional view taken along the line A-A′ in FIG. 7; and

FIG. 9 is a view showing a mold for injection molding the rear panel and tub in FIG. 7.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they would unnecessarily obscure the features of the subject matter of the present disclosure.

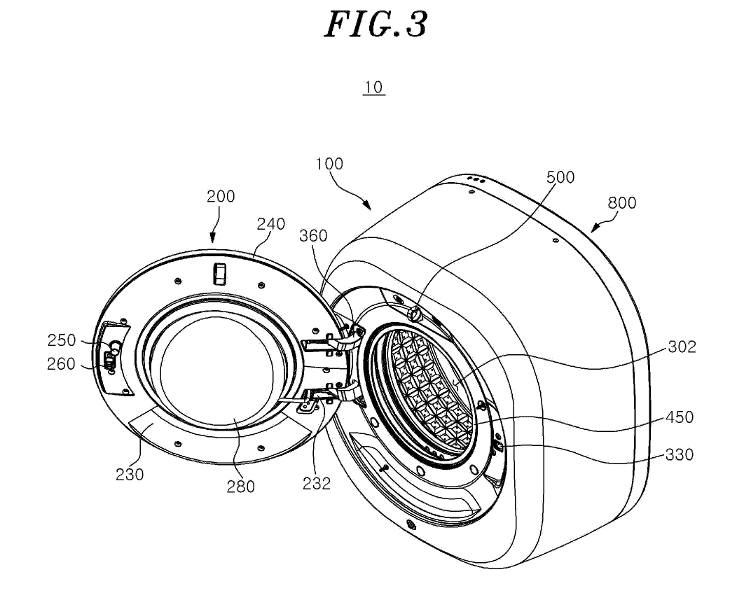

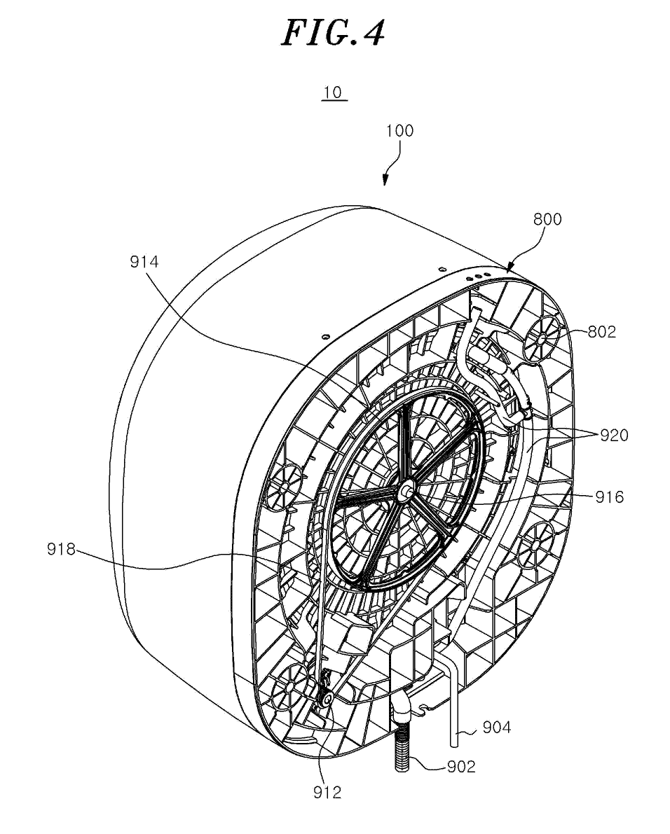

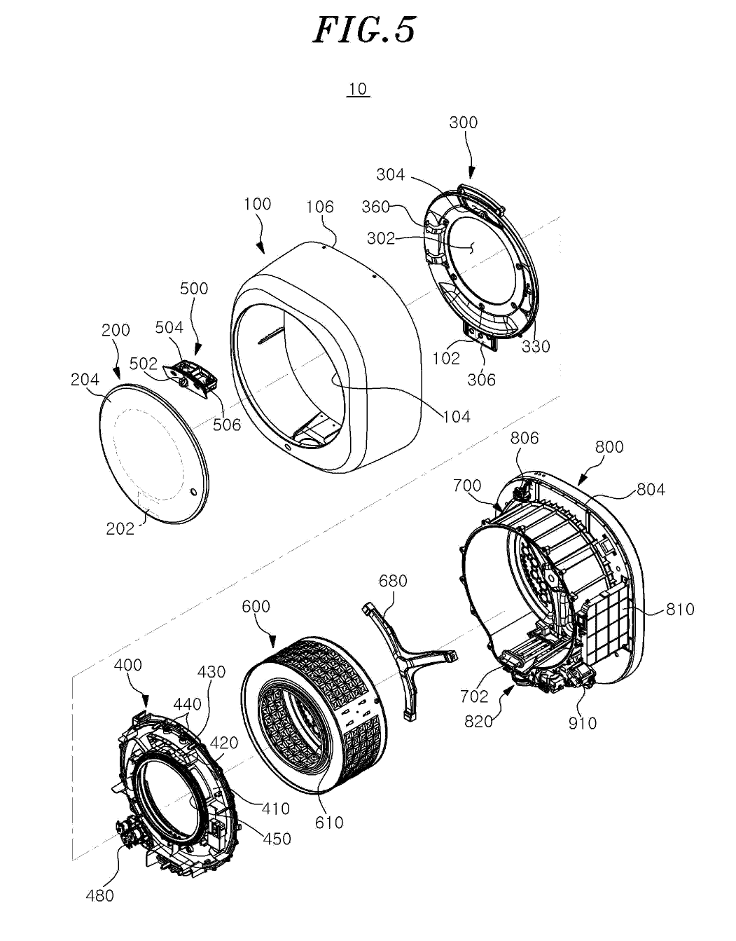

FIG. 2 is a perspective view showing an appearance of a wall mounted washing machine according to an embodiment of the disclosure, FIG. 3 is a view showing a state where a door of FIG. 2 is open, FIG. 4 is a rear view perspective view of a washing machine of FIG. 2, FIG. 5 is an exploded perspective view of the washing machine of FIG. 2.

Referring to FIGS. 2 to 7, a wall-mounted washing machine 10 according to an embodiment of the present disclosure may include a cabinet 100 having a front surface and a rear surface opened and forming an outer appearance, a door 200 disposed on one side of the cabinet 100 and for opening or closing the opened front surface of the cabinet 100, a cover 300 connected to the door 200 for opening and closing the door 200, a front panel 400 disposed on the rear surface of the cover 300, a detergent container 500 housed in one side of the front panel 400 and accommodating detergent and conditioner, a drum 600 in which laundry is stored, a tub 700 which surrounds the drum 600 and is filled with wash water, and a rear panel 800 mounted on the wall. Here, the rear surface means a surface close to the wall, and the front surface means a surface opposite to the rear surface.

Specifically, the cabinet 100 may be provided in an empty form. Also, the cabinet 100 may include a power button 102 for controlling a power supply, a cover connection unit 104 connected to the cover 300, and a rear panel connection unit 106 connected to the rear panel 800.

The power button 102 may be provided on one side of the cabinet 100 to control whether the washing machine 10 is turned on or off. The power button 102 may be provided on one side of the front surface of the cabinet 100 to be easily controlled by the user. Here, in this embodiment, the power button 102 is provided on the lower surface of the front surface of the cabinet 100. However, the position of the power button 102 is not limited thereto, and may be provided on the left or right of the front surface of the cabinet 100, for example, or in other well known positions.

In the embodiments of the disclosure, based on FIGS. 2 and 3, the side where the detergent container 500 is provided on the washing machine 10 is referred to as the upper side, and the side where the power button 102 is provided on the washing machine 10 is referred to as the lower side. In addition, a side on which the door opening button 210 is provided is referred to as the right side, and a side on which the door hinge 360 is provided is referred to as the left side.

The cabinet 100 may include a cover connection unit 104 connected to the cover 300. The cover connection unit 104 may correspond to an edge of the opened front surface of the cabinet 100 and may have a smaller diameter than the diameter of the cover 300 so that the cover 300 is not detached from the cabinet 100. Specifically, the cover 300 may be inserted into the cabinet 100 from the rear surface to the front surface side. In this case, since the diameter of the cover connection unit 104 is smaller than the diameter of the cover 300, the cover 300 may be fitted into the cover connection unit 104, so that the cover 300 may not be separated from the cabinet 100.

The cabinet 100 may include a rear panel connecting unit 106 connected to the rear panel 800. The rear panel connecting unit 106 may correspond to the opened rear edge of the cabinet 100 and may have a shape that corresponds to the shape of the rear panel 800. The cabinet 100 may be bolted to the rear panel 800 and for this purpose, a plurality of bolt fastening holes may be formed in the rear panel connecting portion 106

Meanwhile, the door 200 may be provided on the front surface of the cabinet 100. The door 200 is provided for loading and unloading laundry, and may include a door inner frame 230 and a door outer frame 240. Specifically, the door inner frame 230 and the door outer frame 240 may be bolted in such way to offer a predetermined space therebetween, and each may be provided in a circular shape having a diameter corresponding to the cover connection unit 104. In this case, the door inner frame 230 may be in contact with the cover connection unit 104, and the door inner frame 230 and the door outer frame 240 may completely shield the cover 300 connected to the cabinet 100.

The door inner frame 230 and the door outer frame 240 may include a door hinge connection unit 232 for connection with the cover 300. The door hinge connecting unit 232 is provided at one side of the door inner frame 230 and the door outer frame 240 and may provide a space for accommodating a door hinge 360 of the cover 300 to be described later.

A display 202 may be provided in a space between the door inner frame 230 and the door outer frame 240. The display 202 is capable of outputting predetermined information to the user, and is provided with a front surface exposed to the outside of the door outer frame 240. That is, the door outer frame 240 may include a hole (not shown) or may be formed of a transparent material so that the display 202 may be viewed. In this case, the display 202 may include a touch panel capable of inputting or outputting information, and the user may view the panel to confirm information such as the operating state through the display 202, and also use the panel to perform operations of the wall-mounted washing machine 10 via touch interactions. For example, the user may select a process such as washing and rinsing of the laundry by performing a touch interaction with respect to the display 202, and confirm the remaining washing time or the like through the display 202.

The display 202 exposed to the exterior of the door outer frame 240 and the door outer frame 240 may be protected through a protective glass 204. The protective glass 204 is transparently provided on the front surface of the door outer frame 240 so that the user may identify the display 202. In this case, the protective glass 204 may be provided with the same diameter as the door inner frame 230 and the door outer frame 240.

A hole (not shown) may be provided on one side of the protective glass 204, and the door opening button 210 may be exposed to the outside through the hole (not shown). The door opening button 210 may be provided in the door outer frame 240 for opening or closing the interior of the cabinet 100 using an electronic opening and closing system and may be exposed to the outside through a hole of the protective glass 204.

In addition, the door 200 may include a door opening unit 250 and a door hanging unit 260. The door opening unit 250 and the door hanging unit 260 may protrude rearward of the door inner frame 230 and may be in contact with and engaged with one side of the cover 300. Specifically, the door opening unit 250 serves as an opening/closing assistant and may have an elastic force. For example, the door opening unit 250 may include a spring and may act as a support for opening the door 200 through the elastic force of the spring. For example, when the door 200 is closed, the door opening unit 250 may be compressed and inserted into a groove (not shown) provided on one side of the cover 300. When the user operates the door opening button 210 to open the door 200, the door opening unit 250 may be released from one side of the cover 300, and may be in contact with the bottom surface of the groove (not shown) provided on one side of the cover 300 in a relaxed state. That is, a space is provided between the door 200 and the cover 300 by the relaxed length of the door opening unit 250, thereby preventing the door 200 from being automatically closed.

The door opening unit 250 may be a pusher stem assembly that may be supported by the spring and located within a guide structure formed in the door inner frame 230 or repeatedly perform projecting by a linear movement through a predetermined stroke range.

The door hanging unit 260 may be provided at a predetermined distance from the door opening unit 250 and may be provided in the shape of a hook partially protruding from the door inner frame 230. The protruding portion of the door hanging unit 260 may be coupled to a door lock unit 330 of the cover 300 to be described later, and thus the door 200 may be closed.

In summary, the door 200 according to one embodiment of the present disclosure may be opened through a door opening button 210. When the user operates the door opening button 210, the door opening unit 250 and the door hanging unit 260 may be released from the cover 300 so that the door 200 may open the cover 300. In this case, the door opening unit 250 having an elastic force may be relaxed and provided on one side of the cover 300, and thus a predetermined gap is provided between the door 200 and the cover 300. Therefore the door 200 may be prevented from closing.

In addition, the user may close the door 200 by applying pressure to the door 200 toward the cover 300 side. To this end, the user may press one side of the outermost protective glass 204 of the door 200 so that the door opening unit 250 may be compressed and become received in the groove (not shown) of the cover 300 and the protruding portion of the door hanging unit 260 may be coupled to the door hanging unit 330 of the cover 300. That is, the door 200 may be opened and closed without a separate handle.

A center side of the door inner frame 230 and the door outer frame 240 may be opened and the door glass 280 may be provided at the opened center side. The door glass 280 allows the user to view the laundry inside the machine from the outside of the washing machine 10 and may be fitted to the door inner frame 230 and the door outer frame 240. In this case, the door glass 280 may be formed to protrude rearward, and the protruded side of the door glass 280 may be fitted to the opened side of the cover 300.

Meanwhile, the door 200 may be rotatably connected to the cover 300. The cover 300 is provided to enclose the front panel 400 and may include a laundry inlet 302 for loading the laundry, a detergent container loading port 304 for loading a detergent container 500, and a power processing unit 306 for controlling the button 102.

The user may load laundry through the laundry inlet 302. The laundry inlet 302 may be provided to have a predetermined diameter. In this case, the diameter of the laundry inlet 302 may correspond to the size of the protruding portion of the door glass 280. Thus, when the door 200 is closed, the door glass 280 may block the laundry inlet 302, and when the user opens the door 200, the door glass 280 is released from the laundry inlet 302 to allow laundry loading through the laundry inlet 302.

A detergent container loading port 304, which may load the detergent container 500, may be provided on the upper side of the laundry inlet 302. In this case, the detergent container loading port 304 may correspond to the shape of the detergent container 500.

The cover 300 may have a laundry inlet 302 at its center and may have a circular shape as a whole. Further, the cover 300 may be shaped such that one side protrudes downward. In this case, the power processing unit 306 may be provided in a protruding portion downward. The power processing unit 306 may be a PCB substrate connected to the power button 102 to control whether the power is turned on or off according to the operation of the power button 102 protruding from the outside of the case 100.

Meanwhile, the cover 300 may include a door hanging unit 330 located at a position corresponding to the other door hanging unit 260. The door hanging unit 330 is coupled to the hook-shaped door hanging unit 260 and may include a groove corresponding to the shape of the door hanging unit 260. Thus, as the door hanging unit 260 is coupled to the other door hanging unit 330, so that the door 200 may close the laundry inlet 302.

Also, the cover 300 may include a door hinge 360 at a location corresponding to the door hinge connection unit 232. The door hinge 360 may be opened while one side of the door 200 and one side of the cover 300 may be connected to each other, and the one side of the door hinge 360 may be received in the door hinge connection unit 232. Specifically, the door hinge 360 may be formed in a shape of a long curved panel in a vertical direction on one side of the laundry inlet 302, and may be partially protruded forward such that the door 200 may be rotated and connected to the door hinge connection unit 232. That is, the door 200 may be rotatable along the protruding portion in front of the door hinge 360.

Meanwhile, a front panel 400 may be provided on the rear surface of the cover 300. The front panel 400 may be coupled to the tub 700 and may include a shield unit 410 shielding a space between the drum 600 and the tub 700, a detergent container receiving unit 420 receiving the detergent container 500, a detergent container gasket 430 which provides a seal at a portion coupled with the detergent container 500, a fitting 440 for supplying water into the detergent container 500, a door gasket 450 which provides a seal at a portion in contact with the door 200, and a water supply valve assembly 480 for receiving wash water from an external water supplying source.

The shield unit 410 may shield a space generated between the drum 600 and the tub 700 and may have a shape corresponding to the shape of the cover 300. That is, it may have the same diameter as the cover 300 and have an opening corresponding to the laundry inlet 302 provided on the center side thereof. In this regard, the opening of the shield unit 410 may be smaller than the diameter of the drum 600, so that the space between the drum 600 and the tub 700 may be shielded.

The detergent container receiving unit 420 may be provided at one side of the shield unit 410 to receive the detergent container 500. The detergent container receiving unit 420 may have a shape corresponding to the shape of the detergent container 500 and may be in communication with the detergent container loading port 304 of the cover 300. That is, the detergent container 500 may be received in the detergent container receiving unit 420 via the detergent container loading port 304 of the cover 300.

The detergent container receiving unit 420 may include a detergent container gasket 430 that is pressurized by the detergent container 500. The detergent container gasket 430 may be disposed around the end of the detergent container receiving unit 420 to seal the detergent container 500 and may be composed of a rubber material. That is, the detergent, the conditioner, and the wash water supplied to the detergent container 500 are prevented from leaking to the outside through the detergent container gasket 430.

At least one fitting 440 may be provided on the top of the detergent container receiving unit 420. The fitting 440, which is connected to a water supply valve assembly 480 connected to an external water supply source, may supply the wash water into the detergent container 500. Thus, the wash water supplied to the drum 600 and the tub 700 may include the dissolved detergent or conditioner because the wash water is supplied into the drum 600 and the tub 700 through the detergent container 500.

Meanwhile, the opening of the shield unit 410 may include a door gasket 450 which is pressed by a door glass 280 of the door 200. The door gasket 450 may be disposed at the opening end of the shield unit 410 (for example, at the annular end of the opening) to hermetically fix the door glass 280, and it may be composed of a rubber material or the like. Thus, when the door 200 is closed, the door glass 280 penetrating the laundry inlet 302 of the cover 300 presses the door gasket 450, and therefore the wash water inside the drum 600 and the tub 700 will not leak outside the door 200.

The fitting 440 may be supplied with wash water through a water supply valve assembly 480. The water supply valve assembly 480 may be connected to an external water supply source and may selectively supply the wash water to the detergent container 550 through the fitting 440. The water supply valve assembly 480 may be a three-way valve and two of the supply flow paths extending from the water supply valve assembly 480 may be connected to the fitting 440 connected to the detergent container 500 and one of them may supply the wash water to the drum 600 directly through the door gasket 450.

The detergent container 500 may accommodate detergent and conditioner and may include a detergent container handle 502, a detergent input space 504 in which detergent is loaded, and a conditioner input space 506 in which a conditioner is loaded.

The detergent container handle 502 may protrude forward and may be exposed to the outside of the cover 300. The user thus may grasp the detergent container handle 502 after opening the door 200, allowing the detergent container 500 to be unloaded or inserted from the detergent container receiving unit 420. In this embodiment, although the detergent container handle 502 is extended in the vertical direction and provided at the center of the front surface of the detergent container 500, the detergent container handle 502 is not limited thereto. For example, the detergent container receiving unit 420 may be extended in the horizontal direction and provided on the front surface of the detergent container 500.

The detergent container 500 may be partitioned based on the center of the interior and include a detergent input space 504 and a conditioner input space 506 which may contain detergent and conditioner, respectively. In this connection, the fitting 440 may be arranged to correspond with the detergent input space 504 and the conditioner input space 506, and the detergent and conditioner in the detergent input space 504 and the conditioner input space 506 may be supplied with the wash water. Specifically, the user may draw the detergent container 500 from the detergent container receiving unit 420 after opening the door 200 and may fill detergent and conditioner into the detergent input space 504 and the conditioner input space 506, respectively. The detergent container 500 filled with the detergent and the conditioner may be inserted again into the detergent container receiving unit 420, and depending on the washing process, the detergent input space 504 and the conditioner input space 506 may be supplied with the wash water. Accordingly, the wash water including detergent or conditioner may be selectively supplied to the drum 600 and the tub 700.

Meanwhile, the front panel 400 may be connected to the drum 600. The drum 600 for receiving the laundry may include a drum inlet portion 610 on the front surface and a spider 680 on the rear surface. In this case, a plurality of holes may be formed around the drum 600 for fluid communication with the tub 700.

A drum inlet portion 610 may correspond to the opened portion of the shield unit 410. In this regard, the drum inlet portion 610 may have a diameter smaller than the entire diameter of the drum 600, and the drum inlet portion 610 may be fitted into the opened portion of the shield unit 410, so that front panel 400 and the drum 600 may be connected to each other. Thus, the laundry may be loaded into the drum 600 via the laundry inlet 302 of the cover 300 and the opened portion of the front panel 400.

The drum 600 may be rotated through a spider 680. The spider 680 may rotate in response to a driving force from a driving motor 910 (to be described later). The spider 680 may be separate from the drum 600 and also coupled to the rear surface of the drum 600. In this case, a groove corresponding to the shape of the spider 680 may be formed on the rear surface of the drum 600 so that the spider 680 may be seated.

The spider 680 may include a plurality of arms extending in different directions with a constant gap at the center. For example, the spider 680 may include an arm extending in three directions by a length corresponding to the radius of the drum 600, and each arm may be disposed at a 120-degree gap. Further, the center of the spider 680 may be fixed to a second pulley 914 (to be described later) through a drum rotation axis 916 to be described later, and thus both the drum 600 coupled to the spider 680 and the spider 680 may be rotated. A specific method of rotating the drum 600 will be described later.

A tub 700 in which the wash water is filled may be provided outside the drum 600. The tub 700 may have a shape corresponding to the drum 600 and may be formed with a diameter larger than a diameter of the drum 600 by a predetermined length. Accordingly, the tub 700 may be arranged apart from the drum 600 by a predetermined gap. In addition, the wash water supplied into the tub 700 may flow into the drum 600 through a plurality of holes formed around the drum 600. Similarly, the inner wash water of the drum 600 may flow into the tub 700 through the plurality of holes formed around the drum 600. In this regard, the drum 600 and the tub 700 may be provided in a cylindrical shape, but of course are not limited thereto.

Further, the tub 700 may include a heater 702 to heat the wash water. Specifically, a groove may be formed on the inner side of the tub 700 to receive the heater 702, and a heater 702 may be provided on the inner side of the tub 700 in a detachable manner. Thus, the heater 702 may heat the wash water filled in the tub 700.

Meanwhile, the tub 700 may be integrally provided with a rear panel 800. The rear panel 800 may be mounted on the wall and may include an anchor connection unit 802 to which an anchor (for mounting to the wall) is connected, a cabinet fixing unit 804 for fixing the cabinet 100, and a sensor 806 for detecting the water level.

Specifically, the tub 700 and the rear panel 800 may be integrally injection molded, and the tub 700 may protrude from the front of the rear panel 800. The rear surface of the rear panel 800 may be mounted on the wall via a separate anchor. The anchor may be coupled to the wall through an anchor connection unit 802 and may be provided on the rear surface of the rear panel 800 for stable engagement. That is, the plurality of anchors may mount the rear panel 800 on the wall. In this case, since the tub 700 and the rear panel 800 are integrally provided, a separate damper or an elastic member for supporting the tub 700 is not required. Consequently, the number of parts may be reduced, and the size of the washing machine 10 may be likewise reduced.

The cabinet 100 may be coupled to the front surface of the rear panel 800 where the tub 700 is provided to enclose the tub 700. In this case, a cabinet fixing unit 804 may be provided to have a stepped shape along the periphery of the rear panel 800, and the cabinet 100 may be fixed to the cabinet fixing unit 804. For this purpose, a fastening member such as a bolt may be used.

Also, the rear panel 800 may include a control unit 810 for controlling the overall functions of the wall mounted washing machine 10 and a drain unit 820 for discharging the wash water filled in the tub 700.

The control unit 810 may be provided on the front surface of the rear panel 800 to control various components of the wall mounted washing machine 10 depending on a user's operation to perform laundry washing. In this embodiment, while the control unit 810 is shown on the right side of the respect to tub 700, the position of the control unit 810 is not limited thereto.

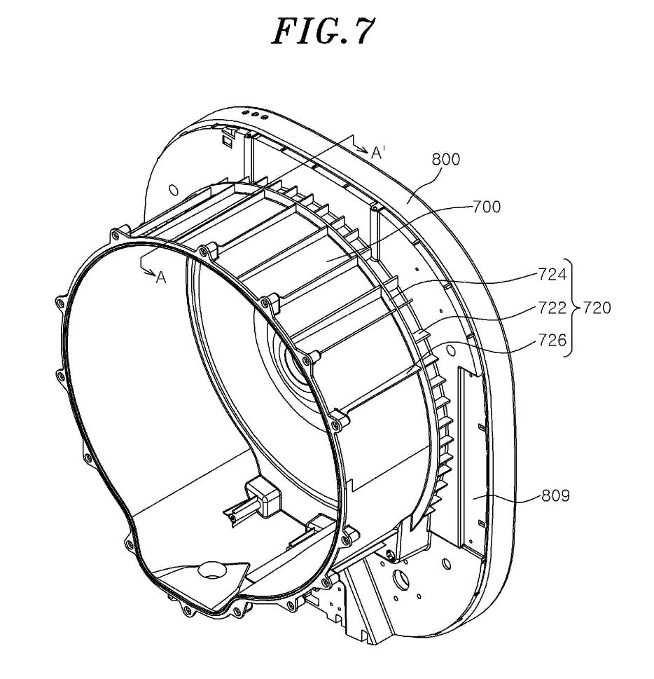

A control unit installation part 809 (see FIG. 7) may be provided on the rear panel 800 for installation of the control unit 810. The control unit installation part 809 may be fixed on one side of the control unit 810.

A power supply line 904 may be connected to the external power source to supply power to the electric equipment, the control unit 810, the driving motor 910, and the like described above. The power supply line 904 may extend through the rear panel 800 to the front of the rear panel 800 and may extend outwardly from the rear of the rear panel 800. In this case, the power supply line 904 may be fixed to the rear surface of the rear panel 800 through a separate fixing means. As the power supply line 904 is provided extending outwardly from the rear surface of the rear panel 800, the washing machine 10 may have a finished or pleasing appearance.

The drain unit 820 may be provided under the rear panel 800. The drain unit 820 may discharge any wash water inside the tub 700 to the outside and may be disposed on the lower surface of the front surface of the rear panel 800. In this case, the drain unit 820 may include a drain pump for pressurizing the wash water and may be connected to the drain hose 902 to discharge the wash water. Specifically, the drain hose 902 is connected to the drain unit 820 and extends outward along the rear surface of the rear panel 800, so that the wash water may flow through the pressure of the drain unit 820. Thus, when the drain unit 820 is operated after the washing cycle is completed, the wash water may be discharged to the outside of the cabinet 100 through the drain hose 902 under the pressure change of the drain unit 820.

The rear panel 800 may include a driving motor 910 for transmitting a driving force to the rear panel 800, a first pulley 912 and a second pulley 914 connected to the driving motor 910, a drum rotational shaft 916 connected to the second pulley 914 to rotate the drum 600, and a belt 918 that connects the first pulley 912 and the second pulley 914.

Specifically, the driving motor 910 may be provided on the front surface of the rear panel 800. The driving motor 910 may be controlled by the control unit 810 and may be provided on one side of the control unit 810 and the drain unit 820.

Also, the driving motor 910 may be connected to the first pulley 912. In this case, the shaft (not shown) of the driving motor 910 may be provided through the rear panel 800 and may be connected with a shaft (not shown) of the driving motor 910 the first pulley 912 at the rear surface of the rear panel 800.

The first pulley 912 may be connected to the second pulley 914 via a belt 918. The second pulley 914 may surround the drum rotation shaft 916 which is connected to the spider 680 and the drum rotation axis 916 may penetrate the rear panel 800 while being connected to the spider 680. That is, the second pulley 914 and the drum rotation shaft 916 may be connected to each other at the rear surface of the rear panel 800.

In summary, when the wash water is filled in the tub 700 through the fitting 440, the control unit 810 may operate the driving motor 910. Subsequently, the first pulley 912 connected to the driving motor 910 may rotate, and the second pulley 914 may be then rotated by the rotation of the first pulley 912. Thus, the drum rotation shaft 916 connected to the second pulley 914 may also rotate so that the drum 600 may be rotated inside the cabinet 100 and the tub 700. Consequently, the laundry inside the drum 600 may be washed.

On the other hand, the rear panel 800 may further include an exhaust line 920. The exhaust line 920 may be connected to the drain unit 820 and may exhaust air inside the tub 700 and the drain unit 820. Specifically, the exhaust line 920 may be connected to the drain hose 902 and pass through the rear panel 800, through which it may extend to the rear surface of the rear panel 800 and exhaust to the outside.

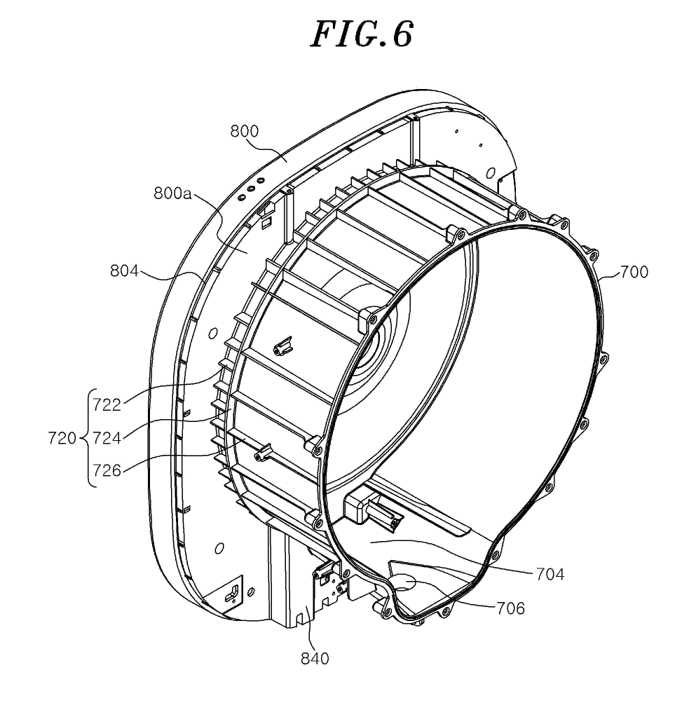

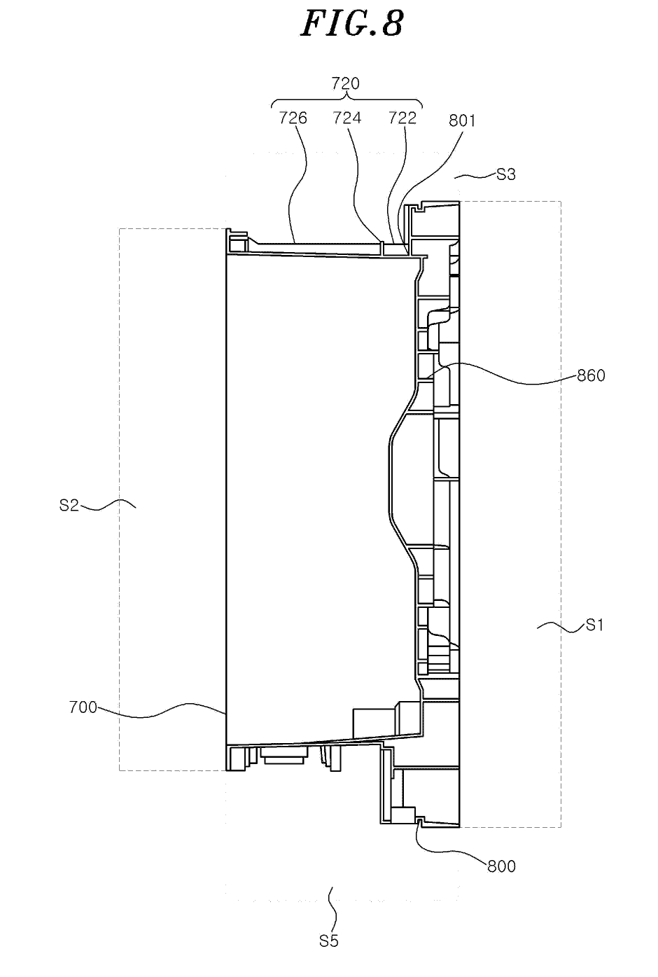

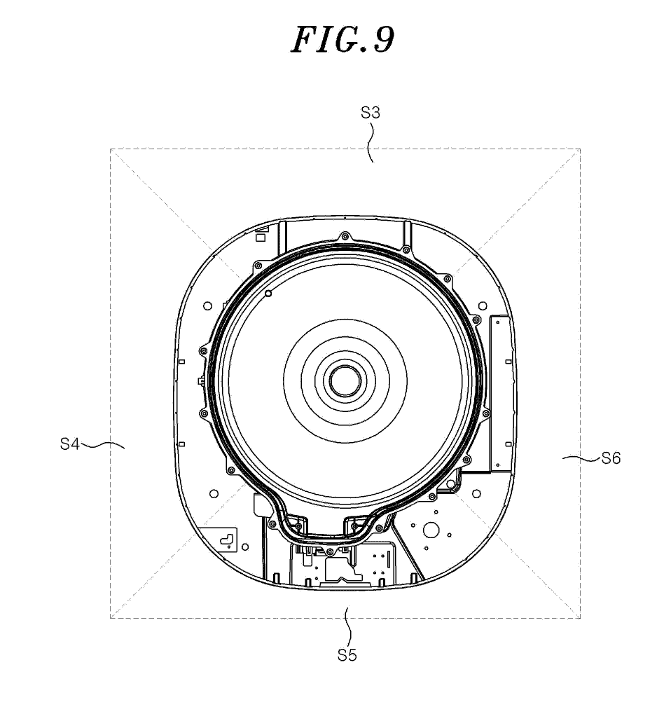

FIG. 6 is a perspective view showing the left side surfaces of the rear panel and the tub in FIG. 5, FIG. 7 is a perspective view showing the right side surfaces of the rear panel and the tub in FIG. 5, FIG. 8 is a cross-sectional view taken along the line A-A′ in FIG. 7, and FIG. 9 is a view showing a mold for injection molding the rear panel and tub in FIG. 7.

Referring to FIGS. 6 to 9, the rear panel 800 and the tub 700 may be integrally formed together. According to the present embodiment, the tub 700 may be formed integrally by extending from the front surface 800a of the rear panel 800 through the injection molding process.

The tub 700 may be formed by protruding forward of the rear panel 800 with one end of the outer circumferential surface of the tub 700 being in contact with the front surface of the rear panel 800 at a predetermined angle. In this case, the tub 700 does not have a step from one end to the other end of the tub 700 which meets the front surface 800a of the rear panel 800, and may extend in a straight line fashion or shape. Therefore, the cross-section of the front surface 800a of the rear panel 800 and the tub 700 may be formed into an ‘L’ shape.

In order to prevent damage due to vibrations and shakings caused by the driving motor and in order to reinforce the strength to support the load of the tub filled with the wash water (and the laundry accommodated in the tub 700), the tub-integrated rear panel 800 may include a reinforced portion 720 provided along the outer circumferential surface of the tub 700, a drain unit installation part 840 provided to allow the drain unit 820 to be installed below the tub 700, and a rear surface reinforcing rib 860 provided on a rear surface of the rear panel 800.

First, the reinforcing portion 720 may be formed to reinforce the strength of the rear panel 800 operable to be mounted on the wall surface and the tub 700 protruding from the rear panel 800, from the vibration of the washing machine 10 and the load of the wash water and the laundry. The reinforcing portion 720 may include first ribs 722, second ribs 724 and third ribs 746 and may be formed along the outer circumferential surface of the tub 700.

The first ribs 722 may be provided in connecting portions 801 of the front surface 800a of the tub 700 and the rear panel 800 and extend vertically forward from the front surface of the rear panel 800, and may be connected to an outer circumferential surface of the tub 700 to provide plural contact points.

The second ribs 724 may protrude vertically from the outer circumferential surface of the tub 700 to be perpendicular to the first ribs 722 and may be formed in parallel with the front surface 800a of the rear panel 800 in a band like shape. In this case, the second ribs 724 formed on the tub 700 are formed closer to the rear panel 800 than the front panel 400 to reinforce the strength of the side portion of the tub 700 protruding from the rear panel 800. Since the portion adjacent to the rear panel 800 (from the tub 700) is most affected by the driving force by the driving motor, it is necessary to reinforce against the vibration due to the driving forces of the washing machine. Therefore, it is desirable to form more ribs on one side of the tub 700 that is most affected by these driving forces.

In addition, the second ribs 724 may protrude higher than the first ribs 722 by a predetermined height. Herein, the predetermined height is selected such that the height does not cause interference of the second ribs 724 on other elements that are disposed in the space between the tub 700 and the cover 300, and may be selected as a height, for instance, that is centered between the first ribs 722 and the third ribs 726.

The third ribs 726 may extend perpendicularly to the second ribs 724 from the front surface of the second ribs 724 to the front end portion of the tub 700 and a plurality of the third ribs may be connected to the outer circumferential surfaces of the tub 700. These third ribs 726 may protrude to the same height as protrude the first ribs 722 from the outer circumferential surface of the tub 700.

In addition, the respective third ribs 726 may be disposed to face an end portion of the first ribs 722 with respect to the second ribs 724, and the third ribs 726 may be disposed on the first ribs 722 in the same line. In addition, the third ribs 726 and the first ribs 722 located on the same line may have the same angle with respect to the tub 700.

As described above, since the connecting portions 801 of the tub 700 and the rear panel 800 are most affected by the vibrations and shaking due to the driving forces, the first ribs 722 provided in the connecting portion 801 of the tub 700 and the rear panel 800 may be provided in greater number than the third ribs 726 which are provided in the front end portion of the tub 700. Accordingly, some of the plurality of first ribs 722 may be provided which do not face the third ribs 726. In other words, some of the first ribs 722 may disposed in the same lines as the third ribs 726 and face the third ribs 726, and other ones of the first ribs 722 on the lines in which the third ribs 726 are not provided may be disposed such that they do not face the third ribs 726. For example, the number of the first ribs 722 may be formed to be twice as many in number as the number of the third ribs 726. Thus, since the first ribs 722 are spaced apart from each other with a greater distance, the strength of the starting point at which the tub 700 protrudes from the rear panel 800 may be further advantageously reinforced.

In addition, some of the first ribs 722 and the third ribs 726 formed on the upper side of the tub 700 may protrude upwardly, also, other ones of the first ribs 722 and the third ribs 726 formed on the left side of the tub may protrude to the left, and the other ones of the first ribs 722 and the third ribs 726 formed on the right side of the tub may protrude to the right. In addition, a space between 1) some of the first ribs 722 and third ribs 726 protruding upward and 2) other ones of the first ribs 722 and third ribs 726 protruding to the left, may be provided with first ribs 722 and third ribs 726 protruding in a radial direction, e.g., a direction perpendicular to the tangential direction of the first ribs 722. Likewise, a space between 1) some of the first ribs 722 and third ribs 726 protruding upward and 2) the other ones of the first ribs 722 and third ribs 726 protruding to the right may be provided with first ribs 722 and third ribs 726 protruding in a direction perpendicular to the tangential direction of the tub 700. This arrangement helps to prevent the reinforcing portion 720 from interfering when the mold is separated during the injection molding process of the rear panel 800 integrated with the tub 700. In one embodiment, the sides of the tub 700 and the rear panel 800 may be formed by four molds arranged in the directions of the upper, lower, left, and right sides. In this case, a direction of the reinforcing portion 720 may be determined so that the mold does not interfere with the reinforcing portion 720 during the process of separating each mold. A detailed description thereof will be described later with reference to FIG. 8 and FIG. 9.

In addition, the outer circumferential surface of the tub 700 to which the first rib 722 is connected and the outer circumferential surface of the tub 700 to which the third rib 726 is connected may be formed without a stepped shape. Specifically, the tub 700, which is integrally formed and protruded from the rear panel 800, may be a straight protruding shape when protruding from the front surface of the rear panel 800 forward.

The drain unit installation part 840 may be formed to protrude from the lower side of the tub 700 and the rear panel 800. Specifically, a heater accommodating portion 704 provided with a heater 702 is disposed below the tub 700, and a drain hole 706 for draining the stored water inside the tub 700 may be formed in the heater accommodating portion 704. In order to drain the wash water through the drain hole 706, the drain unit installation part 840 may be disposed below the drain hole 706 on the front surface of the rear panel 800 so that the drain unit 820 is positioned below the drain hole 706. The drain unit installation part 840 may be formed to protrude forward and to correspond to the position of the drain hole 706. For example, it may protrude up to the height of the second ribs 724. Accordingly, at least the first ribs 722 may not be formed in the region where the drain unit installation part 840 is formed. In addition, the tub 700, which is integrally formed on the rear panel 800 and protruded by the drain unit installation part 840 protruding forward, may be supported thereby.

The rear surface reinforcing ribs 860 are formed on the rear surface of the rear panel 800, and may be formed as a plurality of ribs. The rear surface reinforcing ribs 860 may include a plurality of circular ribs whose diameters gradually increase from the center of the rear surface of the rear panel 800 in the outer circumferential direction, and may include the ribs connecting the plurality of circular ribs.

In summary, the strength of the integrated rear panel 800 may be reinforced by a reinforcing portion 720 disposed on the outer circumferential surface of the tub 700, and a drain unit installation part 840 and a rear surface reinforcing rib 860, which serve as supports on the lower side of the tub 700.

Referring now to FIGS. 8 and 9, the rear panel 800 and the tub 700, which are integrally formed, may be injection-molded through a plurality of molds. A first mold S1 formed on the rear surface of the rear panel 800 (and disassembled to the rear of the rear panel 800), a second mold S1 formed on the front surface of the tub 700 (and disassembled to the front of the tub 700), a third mold S3 that forms an upper portion of the rear panel 800 and an upper portion of the tub 700 (and is disassembled above the rear panel 800), a fourth mold S4 that forms the left portion of the rear panel 800 and the left portion of the tub 700 (and is disassembled in the left direction of the rear panel 800), a fifth mold S5 that forms the lower portion of the rear panel 800 and the lower portion of the tub 700 (and disassembled downwardly the rear panel 800), and a sixth mold S6 that forms the right portion of the rear panel 800 and the right portion of the tub 700 (and is disassembled in the right direction of the rear panel 800).

The first mold S1 may include rib holes (not shown) for forming the rear surface reinforcing ribs 860 formed on the rear surface of the rear panel 800. The length and thickness of the rear panel 800 may be determined by the first mold S1.

The second mold S2 may include a protrusion (not shown) for forming a space in which the wash water is filled in the tub 700. The thickness and diameter of the tub 700 are determined by the second mold S2, and the amount of laundry and the amount of wash water that may be accommodated in the tub 700 may be determined.

The third mold S3, the fourth mold S4 and the sixth mold S6 may include rib holes formed in a shape corresponding to the first ribs 722, the second ribs 724, and the third ribs 726, respectively, in order to form a plurality of first ribs 722 disposed on the connecting portion 801 of the front surface of the tub 700 and the front panel 800 and extending forward from the front surface of the rear panel 800, and connected to an outer circumferential surface of the tub 700; the second ribs 724 protruding in a strip shape from an outer circumferential surface of the tub 700; and a plurality of third ribs 726 extending from the front surface of the second ribs 724 to the front end portion of the tub 700 and connected to the outer circumferential surface of the tub 700.

However, the rib holes for forming the first rib 722 and the third rib 726 formed in the third mold S3 may be formed in the vertical direction, which is in the upward direction, and the rib holes for forming the first ribs 722 and the third ribs 726 respectively formed in the fourth mold S4 and the sixth mold S6 may be formed in the vertical direction of the left and right sides, respectively. Therefore, the third mold S3, which is disassembled upward, does not interfere with the first ribs 722 and the third ribs 726 protruding upward and the first ribs 722 and the third ribs 726, which are disassembled in the left and right directions, respectively, may not interfere with the first ribs 722 and the third ribs 726 formed in the vertical direction, respectively.

In addition, the first ribs 722 and the third ribs 726 disposed at the boundary between the third mold S3 and the fourth mold S4 may protrude in a direction perpendicular to the tangent of the tub 700, and the third mold S3 and the fourth mold S4 may include L-shaped holes at the interface, respectively. The ‘L’ shaped holes formed in the third mold S3 and the ‘L’ shaped holes formed in the fourth mold S4 are formed symmetrically and oppose each other, so that the first ribs 722 and the third ribs 726 may be formed. The following description is made on a pair of the third mold S3 and the fourth mold S4 by way of example only, but it may be similarly applied to a pair of the third mold S3 and the sixth mold S4. Specifically, the rib holes for forming the first ribs 722 and the third ribs 726 perpendicular to the tub 700 may not be formed at a boundary where the third mold S3 is disassembled above the rear panel 800 and the fourth mold S4 is disassembled to the left. Therefore, the L-shaped holes forming a half of a hole in a direction perpendicular to the tangent of the tub 700 are formed on one side of the third mold S3 facing the fourth mold S4. Likewise, the L-shaped holes forming a half of a hole in a direction perpendicular to the tangent of the tub 700 are formed on the other side of the fourth mold S4 facing the third mold S3. The rib holes in which the ‘L’ shaped holes of the third mold S4 and the fourth mold S4 are in contact with each other may be formed. As such, the ribs to be formed at the interface between the third mold S3 and the fourth mold S4 may be formed as the completed first ribs 722 and third ribs 726 in such a way that the third mold S3 and the fourth mold S4 are interrelated to an extent which is not interfered when the third mold S3 and the fourth mold S4 are disassembled.

The fifth mold S5 may be formed to form a drain unit installation part 840 formed on the lower side of the tub 700 and the rear panel 800.

In addition, the rib grooves may be not formed such that at least third ribs 726 are not formed in a portion of the sixth mold S6 so as not to be interfered by the reinforcing portion 720 when the control unit 810 is located at one side of the tub 700. In the embodiment of the disclosure, although the control unit 810 is disposed on the right side (using the sixth mold S6 as an example), the control unit 810 may also be provided on the left side, and the rib grooves may not be formed such that at least the third rib 726 may not be provided in the fourth mold S4. Specifically, when the control unit 810 of the rear panel 800 is installed, the PCB is disposed such that the electronic components protrude toward the tub 700. Due to the interference between the control unit 810 and the reinforcing portion 720, there is a problem in that the total volume of the wall mounted washing machine 10 is increased by adding a space between the tub 700 and the cover 300 for installing the control unit 810. Thus, in this embodiment, in order to avoid the need for this additional accommodating space, the control unit 810 and the reinforcing portion 720 do not interfere with each other in a portion where the control unit 810 is installed. Moreover, the rib grooves may not be formed such that at least the third ribs 726 are not formed on a portion of the sixth mold S6 in which the control unit 810 is disposed. Accordingly, it is possible to advantageously reinforce the strength of the tub-integrated rear panel 800 without increasing the total volume of the wall mounted washing machine 10.

In summary, the third mold S3 to the sixth mold S6 may be configured such that the circumferential surface of the tub 700 to which the first rib 722 is connected and the outer circumferential surface of the tub 700 to which the third rib 726 may be formed, do not have a stepped shape. That is, the connecting portions 801 for connecting the tub 700 and the rear panel 800 may be formed without a stepped shape, and the reinforcing portion 720 may be formed on the outer circumferential surface of the tub 700. Accordingly, a cooling line for cooling the injection product in the injection molding process may be advantageously disposed between the tub 700 and the connecting portion 801 of the rear panel 800 and the rear surface reinforcing ribs 860, such that cold air may be sufficiently transmitted directly to the reinforcing portion 720.

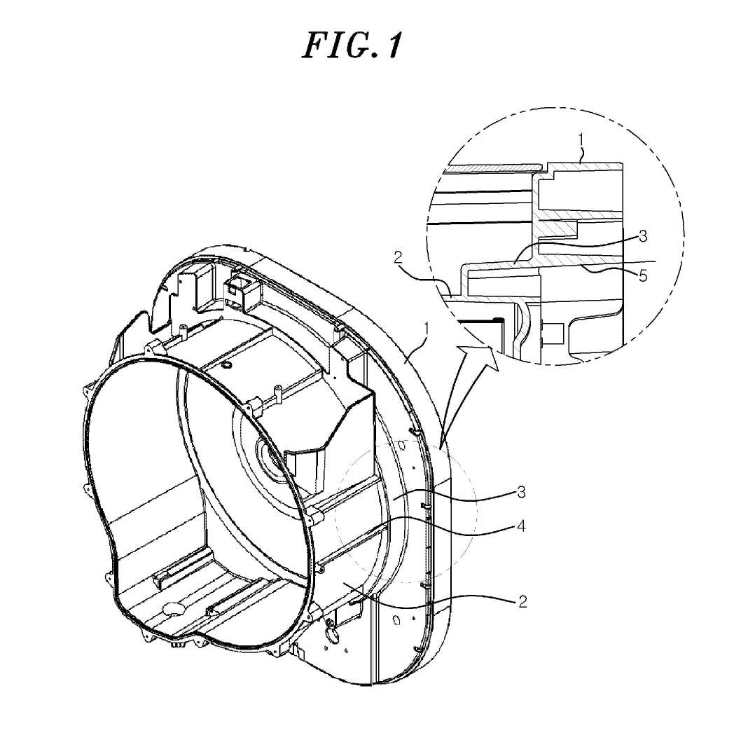

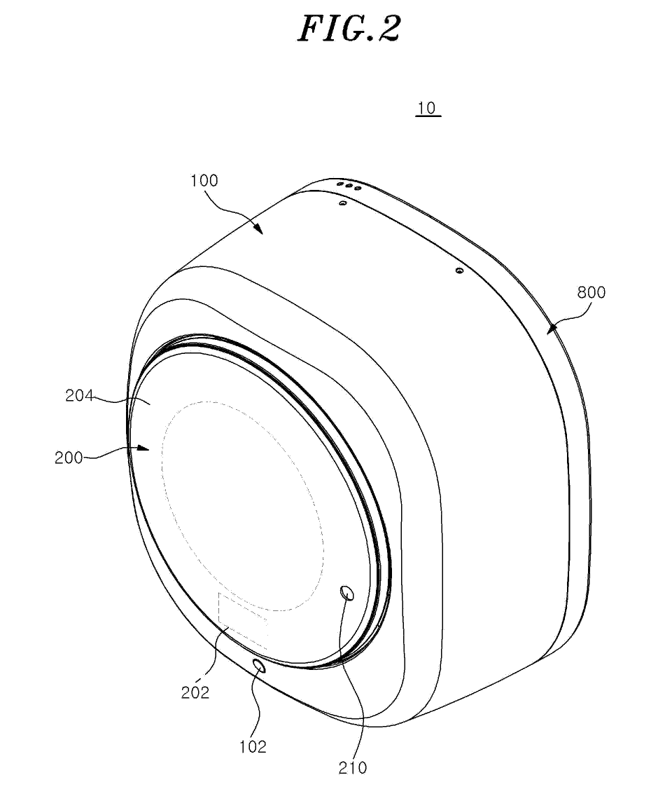

Specifically, the reinforcing portion 2 of the prior art device shown in FIG. 1 is extended and protruded from the front surface of the rear panel 1 to surround the tub 2 and a narrow gap is generated between the outer circumferential surface of the tub 2 formed with a step with the outer circumferential surface of the tub 2 and the inner circumferential surface of the reinforcing portion 3. This arrangement makes it difficult to supply the cooling line. However, according to the present embodiment, the reinforcing portion 720 formed on the outer circumferential surface of the tub 700 does not form a step with the rear panel 800, and is provided on the connecting portion 801 of the tub 700 and the rear panel 800 to extend from the front surface 800a of the rear panel 800, and protrudes from the outer circumferential surface of the tub 700. Accordingly, it is possible to directly transmit the cold air through the cooling line. Therefore, the required cooling cycle time may be advantageously reduced in the injection molding process.

The wall-mounted washing machine 10 according to an embodiment of the present disclosure may be used as follows.

First, the user may open the door 200, and may load the laundry inside the drum 600 and unload the detergent container 500 from the front panel 400. In this case, the detergent container 500 is divided in the center, so that a space for loading detergent and conditioner, respectively, may be provided.

After inserting the detergent container 500 loaded with the detergent and conditioner back into the front panel 400, the user may close the door 200 and control the laundry operation via the power button 102 and the display 202. When the washing cycle is started, the wash water provided from an external water supplying source through the water supply valve assembly 480 may be supplied to the detergent container 500 through the fitting 440, and the wash water may be supplied into the drum 600 and tub 700 after passing the detergent input space 504 and the conditioner input space 506. That is, the wash water filled in the drum 600 and the tub 700 may optionally include detergent and conditioner.

When the tub 700 is fully filed with the wash water, the control unit 810 may drive the driving motor 910. In this case, the driving motor 910 may be connected to the first pulley 912 and the second pulley 914, and the second pulley 914 may be connected to the drum 600 through the drum rotation shaft 916. Thus, the drum 600 may be rotated through the driving motor 910. Consequently, the laundry loaded in the drum 600 may be easily washed by the rotation of the drum 600.

As described above, in accordance with a wall mounted washing machine, an tub-integrated rear panel of the wall mounted washing machine, and a manufacturing mold for manufacturing the tub-integrated rear panel of the wall mounted washing machine according to embodiments of the disclosure, there is an advantage in that the injection molding process may be integrally performed with the rear panel and the tub.

In addition, there is an advantage of reducing the required cooling cycle time for the injection molding process by use of a cooling line.

In addition, there is an advantage of reinforcing the strength of the connection components between the tub and the rear panel.

As set forth above, while the disclosure has been described in connection with a wall mounted washing machine, an tub-integrated rear panel of the wall mounted washing machine, and a manufacturing mold for manufacturing the tub-integrated rear panel of the wall mounted washing machine, it is merely an example and the present disclosure is not limited thereto. It should be construed that the present disclosure has the widest range in compliance with the basic idea disclosed in the disclosure. Although it is possible for those skilled in the art to combine and substitute the disclosed embodiments to embody the other types that are not specifically disclosed in the disclosure, they do not depart from the scope of the present disclosure as well. In addition, it will be apparent to those skilled in the art that various modifications and changes may be made with respect to the disclosed embodiments based on the disclosure in easy and these changes and modifications also fall within the scope of the present disclosure.

What is claimed is:

1. A wall mounted washing machine comprising:
a rear panel operable to be mounted on a wall surface;
a tub formed integrally with the rear panel and extending forward thereof and operable to contain wash water wherein the tub comprises with a strength reinforcing portion;
a drum disposed in the tub and rotatable;
a front panel disposed in front of the tub and having an opening;
a cover disposed to cover the front panel and having an inlet;
a door rotatably coupled to the cover for selectively opening and closing the inlet; and
a cabinet coupled to the rear panel and enclosing the tub, wherein the strength reinforcing portion comprises:
a plurality of first ribs disposed at connecting portions of the tub and a front surface of the rear panel and vertically extending from the front surface of the rear panel and connected to a first outer circumferential surface of the tub;
second ribs protruding from the first outer circumferential surface of the tub perpendicular to the first ribs and formed in parallel with the front surface of the rear panel and having a strip shape; and
a plurality of third ribs extending perpendicular to the second ribs from a front surface of the second ribs to a front end portion of the tub and connected to a second outer circumferential surface of the tub, wherein further
the first and second outer circumferential surfaces of the tub are formed free of any stepped shape.

2. The wall mounted washing machine according to claim 1, wherein some of the first ribs protrude upward, some of the first ribs protrude left, some the first ribs protrude right, and
some of the third ribs protrude upward, some of the third ribs protrude left, and some of the third ribs protrude right.

3. The wall mounted washing machine according to claim 1, wherein a space between some of the first ribs and the third ribs protruding upward and some of the first ribs and the third ribs protruding left and a space between some of the first ribs and the third ribs protruding upward and some of the first ribs and the third ribs protruding right are disposed with the first ribs and the third ribs protruding in a direction perpendicular to a tangent direction of the tub.

4. The wall mounted washing machine according to claim 1, wherein respective third ribs are disposed to face end portions of the first ribs with respect to the second ribs, and make a same angle with respect to the tub.

5. The wall mounted washing machine according to claim 4, wherein some of the first ribs do not face the third ribs.

6. The wall mounted washing machine according to claim 1, wherein the first ribs and the third ribs protruding from the first and second outer circumferential surfaces of the tub are equal in height to each other and the second ribs protrude higher than the first ribs.

7. The wall mounted washing machine according to claim 1, further comprising:
a heater disposed under the tub and wherein a heater accommodating portion is installed with the heater;
a drain hole formed in the heater accommodating portion;
a drain unit installation part formed on a lower side of the drain hole and protruded and formed on a front surface of the rear panel, and wherein
a region wherein the drain unit installation part is formed is free of first ribs.

8. The wall mounted washing machine according to claim 1, further comprising a control unit installed on one side of the rear panel and comprising a circuit comprising electronic components which protrude toward the tub, wherein
the control unit is installed at a position wherein a distance between protruding end portions of the electronic components and a tub surface is shorter than a protrusion height of the third ribs, and wherein further
a portion of the tub facing the control unit is free of any third ribs.

9. In a wall mounted washing machine having a rear panel operable to be fixed to a wall and a tub extending forward from the rear panel, wherein the rear panel is injection-molded with the tub, a reinforcing portion for reinforcing a strength of the tub, wherein the reinforcing portion comprises:
a plurality of first ribs provided on a connecting portion of a front surface of the tub and the rear panel and extending forward from a front surface of the rear panel and connected to a first outer circumferential surface of the rear panel;
second ribs protruding from the first outer circumferential surface of the tub in a strip shape and facing a front surface of the rear panel; and
a plurality of third ribs extending from a front surface of the second ribs to a front end portion of the tub and connected to a second outer circumferential surface of the tub, and wherein
the first and second outer circumferential surfaces of the tub being formed free of a stepped shape.

10. The reinforcing portion according to claim 9, wherein the first ribs are formed perpendicular to a front surface of the rear panel.

11. The reinforcing portion according to claim 9, wherein the second ribs protrude perpendicular to the tub and are formed parallel to a front surface of the rear panel.

12. The reinforcing portion according to claim 9, wherein the third ribs are located on same lines as are the first ribs.

13. The reinforcing portion according to claim 9, wherein the first ribs and the third ribs disposed on a boundary of a mold for manufacturing the tub and rear panel protrude in a direction perpendicular to a tangent of the tub.

14. The reinforcing portion according to claim 9, wherein the wall mounted washing machine further comprises:
a heater having a heater accommodating portion and disposed below the tub;
a drain hole for draining wash water and formed in the heater accommodating portion; and
a drain unit installation part on which a drain unit is disposed and positioned below the drain hole, and wherein further
a region where the drain unit installation part protrudes is free of first ribs.

15. The reinforcing portion according to claim 9, wherein the wall mounted washing machine further comprises:
a control unit comprising a circuit comprising electronic components that protrude toward the tub and is installed on one side of the rear panel,
wherein the control unit is installed at a position wherein a distance between a protruding end portion of the electronic components and the tub surface is shorter than a protrusion height of the third ribs, and wherein further
third ribs are not formed in a portion of the tub facing the control unit.

16. A manufacturing mold for injection molding a tub-integrated rear panel for a wall mounted washing machine, the manufacturing mold comprising:
a first mold forming a rear surface of the rear panel, the rear surface of the rear panel being disassembled;
a second mold forming a front surface of the tub, the second mold being disassembled forward of the tub;
a third mold forming an upper portion of the rear panel and an upper portion of the tub, the third mold being disassembled above the rear panel;
a fourth mold forming a left portion of the rear panel and a left portion of the tub, the fourth mold being disassembled in the left direction of the rear panel;
a fifth mold forming a lower portion of the rear panel and a lower portion of the tub, the fifth mold being downwardly disassembled in the rear panel; and
a sixth mold forming a right portion of the rear panel and a right portion of the tub, the sixth mold being disassembled in the right direction of the rear panel,
wherein the third mold, the fourth mold, and the sixth mold comprise:
rib holes for forming a plurality of first ribs provided on a connecting portion of a front surface of the tub and the rear panel, the first ribs extending forward from a front surface of the rear panel and connected to a first outer circumferential surface of the rear panel;
second ribs protruding from the first outer circumferential surface of the tub in a strip shape and facing the front surface of the rear panel; and
a plurality of third ribs extending from a front surface of the second ribs to a front end portion of the tub and connected to a second outer circumferential surface of the tub, and wherein
the first and second outer circumferential surfaces of the tub are formed without a stepped shape.

17. The manufacturing mold according to claim 16, wherein the first ribs are formed perpendicular to the front surface of the rear panel, the second ribs are formed in parallel with the front surface of the rear panel and protrude vertically from the tub, and the third ribs are formed on same lines as are formed the first ribs.

18. The manufacturing mold according to claim 16, wherein the first ribs and the third ribs disposed at a boundary between the third mold and the sixth mold and a boundary between the third mold and the fourth mold protrude in a direction perpendicular to a tangent of the tub.
